(19) United States
(12) Patent Application Publication
(10) Pub. No.: US 2025/0196231 A1
(43) Pub. Date: Jun. 19, 2025

(54) SYSTEMS AND METHODS FOR MEASURING LAYER TOPOGRAPHY IN THREE-DIMENSIONAL PRINTING PROCESSES

(71) Applicant: Nikon Corporation, Tokyo (JP)

(72) Inventor: Goldie Lynne Goldstein, Tucson, AZ (US)

(73) Assignee: Nikon Corporation, Tokyo (JP)

(21) Appl. No.: 18/848,919

(22) PCT Filed: Mar. 23, 2023
(86) PCT No.: PCT/US2023/016139

§ 371 Date: Sep. 20, 2024

Related U.S. Application Data
(60) Provisional application No. 63/323,915, filed on Mar. 25, 2022.

(51) Int. Cl. B22F 12/90; B22F 10/20; B22F 12/41; B22F 12/45; B22F 12/46; B22F 12/49; B33Y 30/00; B33Y 50/02

(52) U.S. Cl. CPC B22F 12/90; B22F 10/20; B22F 12/41; B22F 12/45; B22F 12/46; B22F 12/49; B33Y 30/00; B33Y 50/02

(57) ABSTRACT

The problem of non-ideal layer geometry in 3D printing processes is addressed by systems and methods that employ laser triangulation measurements in the vicinity of the melt pool. The systems and methods generally direct one or more lasers at one or more locations along or perpendicular to a direction of travel of a 3D printing energy source. The one or more lasers are reflected from the one or more locations and received by an optical detector, which generates one or more signals in response to receiving the one or more reflected lasers. The signals are received by a controller, which determines one or more heights of the surfaces at the one or more locations based on the one or more signals. The lasers are scanned across a layer of a 3D printed part to obtain the height of the surface across the layer.

### CROSS-REFERENCE

The present application claims priority to U.S. Provisional Patent Application No. 63/323,915, filed on Mar. 25, 2022, entitled “SYSTEMS AND METHODS FOR MEASURING LAYER TOPOGRAPHY IN THREE-DIMENSIONAL PRINTING PROCESSES,” which is incorporated herein by reference in its entirety for all purposes.

### BACKGROUND OF THE INVENTION

Certain three-dimensional (3D) printing systems and methods utilize directed energy (for instance, from a laser or an electron beam) to heat metal powders. In powder bed 3D printing processes, the metal powder is deposited as a layer and then an energy source is scanned over the layer to selectively heat the layer in different locations. In powder spraying processes, the metal powder is deposited only to selected locations, which are then heated by the energy source. In either case, a 3D printed metal part is then built by repeating either process layer-by-layer to form a 3D printed part.

As the heating process is performed, a pool of molten metal powder (a so-called “melt pool”) forms at and near the location being heated. Over time, the melt pool cools and hardens. The process continues for a cross section of the part until a layer of the part is formed. The process of melt pool formation and cooling may result in a layer which deviates from an intended layer geometry. For example, the process of melt pool formation and cooling may cause portions of the layer to be too thin, too thick, develop strain or cracks, or present a number of other non-ideal geometric features. Measuring such non-idealities may allow for feedback to produce layers that better conform to the intended layer geometry. Accordingly, presented herein are systems and methods for measuring layer topography in 3D printing processes.

### BRIEF DESCRIPTION OF THE DRAWINGS

Various embodiments of the invention are disclosed in the following detailed description and the accompanying drawings.

FIG. 1 shows a schematic depicting an exemplary system for measuring layer topography in a three-dimensional (3D) printing process.

FIG. 2 shows a schematic depicting a first exemplary laser source for use in combination with the exemplary system for measuring layer topography in a 3D printing process.

FIG. 3 shows a schematic depicting a second exemplary laser source for use in combination with the exemplary system for measuring layer topography in a 3D printing process.

FIG. 4 shows a schematic depicting a third exemplary laser source for use in combination with the exemplary system for measuring layer topography in a 3D printing process.

FIG. 5 shows a schematic depicting a fourth exemplary laser source for use in combination with the exemplary system for measuring layer topography in a 3D printing process.

FIG. 6 shows a schematic depicting a fifth exemplary laser source for use in combination with the exemplary system for measuring layer topography in a 3D printing process.

FIG. 7 shows a schematic depicting a sixth exemplary laser source for use in combination with the exemplary system for measuring layer topography in a 3D printing process.

FIG. 8 shows a diagram of two lasers that can be used to measure surface heights at one or two locations in the vicinity of a melt pool on a layer of a 3D printed part.

FIG. 9 shows a diagram of four lasers that can be used to measure surface heights at one, two, three, or four locations in the vicinity of a melt pool on a layer of a 3D printed part.

FIG. 10 shows a flowchart depicting an exemplary method for measuring layer topography in a 3D printing process.

FIG. 11 shows a block diagram of a computer system for measuring layer topography in a 3D printing process.

FIGS. 12A-D show an example of shifts of a laser triangulation signal across an optical detector with changing distance from a laser source to a location from which a laser is reflected.

FIG. 12A shows an example of a first shift associated with a first distance from the laser source to the location.

FIG. 12B shows an example of a second shift associated with a second distance from the laser source to the location.

FIG. 12C shows an example of a third shift associated with a third distance from the laser source to the location.

FIG. 12D shows an example of a fourth shift associated with a fourth distance from the laser source to the location.

FIG. 13A shows an example of shifts associated with a variety of distances from the laser source, as well as linear fits associated with these shifts.

FIG. 13B shows an example of extrapolated shifts associated with the variety of distances from the laser source shown in FIG. 13A.

FIG. 13C shows an example of a calibration curve determined from the extrapolated shifts shown in FIG. 13B.

FIG. 13D shows an example of a non-linear correction applied to measurements associated with the calibration curve of FIG. 13C.

FIGS. 14A-D show an example of changing grid images associated with changing FOVs to which an optical detector is sensitive with changing distance from a laser source to a location from which a laser is reflected.

FIG. 14A shows an example of a first grid image associated with a first distance from the laser source to the location.

FIG. 14B shows an example of a second grid image associated with a second distance from the laser source to the location.

FIG. 14C shows an example of a third grid image associated with a third distance from the laser source to the location.

FIG. 14D shows an example of a fourth image associated with a fourth distance from the laser source to the location.

FIG. 15 shows an example of 3×3 transformation matrices associated with a variety of grid images.

FIG. 16A shows an example of a first view of a height map associated with a test part and constructed using the systems and methods described herein.

FIG. 16B shows an example of a second view of the height map.

FIG. 16C shows the test part.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying Figures (also, “FIGs.”) that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “or” shall convey both disjunctive and conjunctive meanings. For instance, the phrase “A or B” shall be interpreted to include element A alone, element B alone, and the combination of elements A and B.

As used herein, like numbers in the Figures denote like elements.

Recent work in three-dimensional (3D) printing has allowed the production of additively manufactured metal parts having geometries that are difficult or impossible to manufacture using traditional subtractive manufacturing processes such as milling or lathing. Such 3D printed metal parts may have material properties (such as tensile strength, density, and the like) that are substantially similar to those of metal parts manufactured using the traditional subtractive manufacturing processes. Such 3D printing processes often utilize directed energy, such as laser light or an electron beam to selectively heat metal powders and thereby form layers of a metal part. In powder bed 3D printing processes, the metal powder is deposited as a layer and then an energy source is scanned over the layer to selectively heat the layer in different locations. In powder spraying processes, the metal powder is deposited only to selected locations, which are then heated by the energy source. In either case, a 3D printed metal part is then built by repeating either process layer-by-layer to form a 3D printed part.

As the heating process is performed, a pool of molten metal powder (a so-called “melt pool”) forms at and near the location being heated. Over time, the melt pool cools and hardens. The process continues for a cross section of the part until a layer of the part is formed. The process of melt pool formation and cooling may result in a layer which deviates from an intended layer geometry. For example, the process of melt pool formation and cooling may cause portions of the layer to be too thin, too thick, develop strain or cracks, or present a number of other non-ideal geometric features. Measuring such non-idealities may allow for feedback to produce layers that better conform to the intended layer geometry.

Accordingly, the problem of non-ideal layer geometry in 3D printing processes is addressed by systems and methods that employ laser triangulation measurements in the vicinity of the melt pool. The systems and methods generally direct one or more lasers at one or more locations along or perpendicular to a scanning direction of a 3D printing energy source. The one or more lasers are reflected or scattered from the one or more locations and received by at least one optical detector, which generates one or more signals in response to receiving the one or more reflected or scattered lasers. The signals are received by a controller, which determines one or more heights of the surfaces at the one or more locations based on the one or more signals. The lasers are scanned across a layer of a 3D printed part to obtain the height of the surface across the layer. In this manner, a topography of the layer is obtained, allowing assessment of whether non-idealities have emerged from the 3D printing process and allowing correction of these non-idealities by adjusting any of a number of parameters associated with the 3D printing process. The systems and methods may be employed as the layer is being printed or after the layer has been printed.

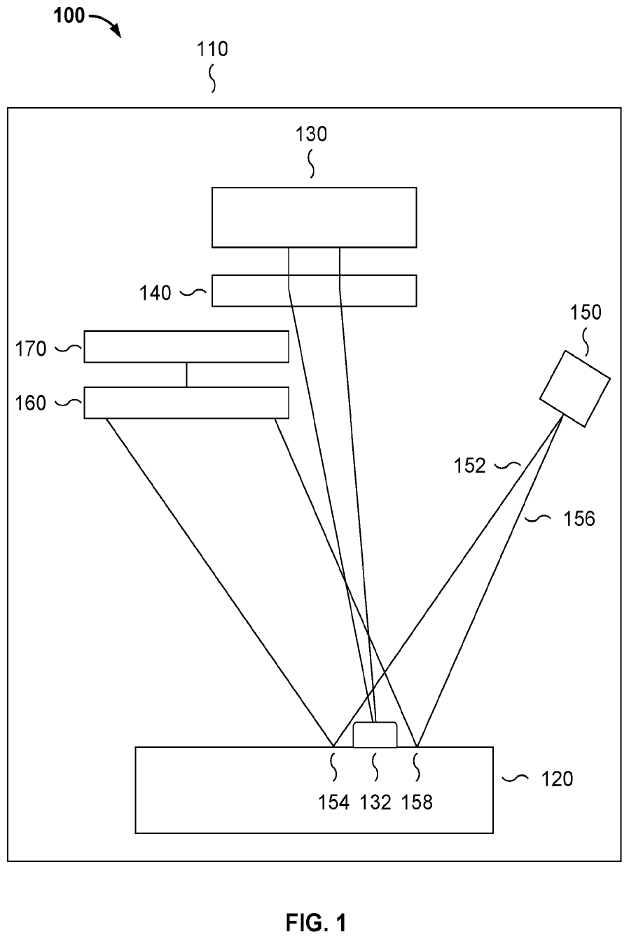

FIG. 1 shows a schematic depicting a first exemplary system 100 for measuring layer topography in a 3D printing process. In the example shown, the system comprises a container 110. In some embodiments, the closed container comprises a gas-tight container. In some embodiments, the closed container comprises a pressure container. In some embodiments, the closed container comprises a vacuum container. In some embodiments, the closed container comprises a high vacuum container. In some embodiments, the closed container comprises an ultra-high vacuum container.

In the example shown, the system comprises a 3D printing melt platform 120 located within the container. In some embodiments, the 3D printing melt platform is configured to support the production of a 3D printed component during a 3D printing process. In some embodiments, the 3D printing melt platform includes a table configured to support the production thereon. Thus, as used herein, the terms “3D printing melt platform” and “table” are interchangeable. Moreover, as used herein, the terms “3D printed component” and “production” are interchangeable. In some embodiments, the 3D printing process comprises a metal bed fusion process, a direct metal laser sintering process, a selective laser melting process, a direct energy deposition method, or a powder spraying method.

In the example shown, the system comprises an energy source 130. In some embodiments, the energy source is located within the container. In some embodiments, the energy source is external to the container. In some embodiments, the energy source is configured to direct energy to the 3D printing melt platform (or to the table or to the production located thereon) during the 3D printing process, thereby generating a melt pool 132 on the 3D printing melt platform (or on the table or on the production located thereon). In some embodiments, the energy source comprises a laser. In some embodiments, the energy source comprises an electron beam. In some embodiments, the energy selectively heats different portions of a layer of metal powder located on the 3D printing melt platform (or on the table or on the production located thereon). In some embodiments, a melt pool position of melt pool 132 is based on an irradiation position of the energy on the 3D printing melt platform (or on the table or on the production located thereon).

In some embodiments, the energy source comprises an optical energy source and the energy comprises optical energy. In some embodiments, the optical energy source comprises a laser energy source and the optical energy comprises laser energy. In some embodiments, the laser energy source is configured to emit continuous wave laser energy. In some embodiments, the laser energy source is configured to emit pulsed laser energy.

In the example shown, the system comprises a scanner 140. In some embodiments, the scanner is configured to move the 3D printing melt platform (or the table or the production located thereon) to scan the irradiation position of the energy along the 3D printing melt platform (or along the table or along the production located thereon). In some embodiments, the irradiation position is scanned by changing a relatively position between the energy and the 3D printing melt platform (or the table or the production located thereon). In some embodiments, the energy source scanner comprises one or more scanning mirrors. In some embodiments, the energy source scanner comprises one or more galvanometers. In some embodiments, the energy source scanner comprises one or more polygonal mirrors.

In the example shown, the system comprises a laser source 150. In some embodiments, the laser source is configured to direct a first laser 152 to a first location 154. In some embodiments, the first laser is a first line laser or a first point laser. In some embodiments, the first location is along the scanning direction. In some embodiments, the first location is ahead of (with respect to the scanning direction) the melt pool 132. In some embodiments, the first location is a first distance ahead of (with respect to the scanning direction) the melt pool. In some embodiments, the first distance is at least about 1 micrometers (μm), 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 millimeters (mm), 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1,000 mm, or more. In some embodiments, the first distance is at most about 1,000 mm, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In some embodiments, the first distance is within a range defined by any two of the preceding values.

In some embodiments, the laser source is configured to direct a second laser 156 to a second location 158. In some embodiments, the second laser is a second line laser or a second point laser. In some embodiments, the second location is along the scanning direction. In some embodiments, the second location is behind the melt pool 132. In some embodiments, the second location is a second distance behind the melt pool. In some embodiments, the second distance is at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1,000 mm, or more. In some embodiments, the second distance is at most about 1,000 mm, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In some embodiments, the second distance is within a range defined by any two of the preceding values. In some embodiments, the irradiation position of the energy directed from the energy source is located between the first location and the second location.

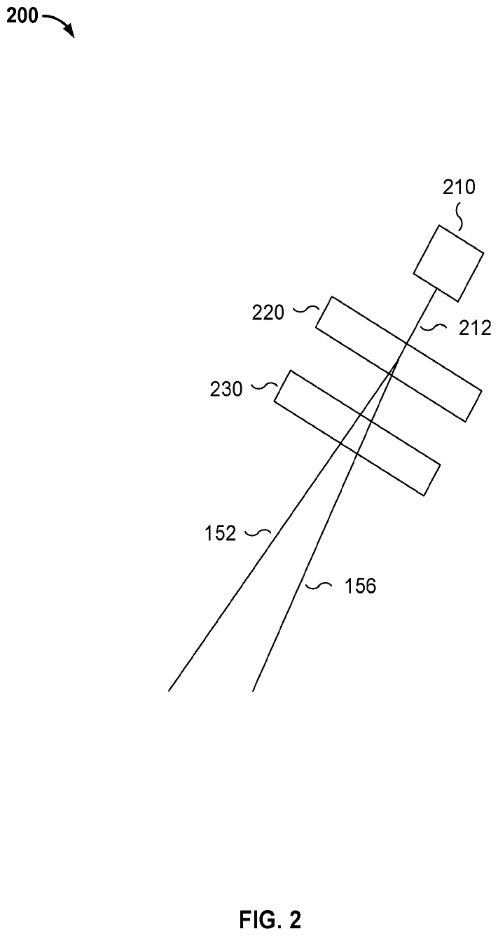

In some embodiments, the first and second distances are the same. In some embodiments, the first and second distances are different. In some embodiments, the laser source comprises any of laser sources 200, 300, 400, 500, 600, or 700 described herein with respect to FIG. 2, 3, 4, 5, 6, or 7, respectively.

In the example shown, the system comprises at least one optical detector 160. In some embodiments, the optical detector is configured to receive a first reflection of the first laser from the first location. In some embodiments, the first reflection comprises a first laser triangulation reflection. In some embodiments, the optical detector is configured to generate a first reflection signal from the first reflection. In some embodiments, the first reflection signal comprises a first laser triangulation signal. In some embodiments, the optical detector is configured to receive a second reflection of the second laser from the second location. In some embodiments, the second reflection comprises a second laser triangulation. In some embodiments, the optical detector is configured to generate a second reflection signal from the second reflection. In some embodiments, the second reflection signal comprises a second laser triangulation signal. Although referred to as utilizing reflections herein, a person having skill in the art will recognize that other scattering interactions may be used in place of reflections. Thus, the term “reflection” should be understood to cover other types of scattering as well.

In some embodiments, the optical detector comprises a photodiode array. In some embodiments, the optical detector comprises a camera. In some embodiments, the optical detector comprises a charge coupled device (CCD) camera. In some embodiments, the optical detector comprises a complementary metal oxide semiconductor (CMOS) camera. In some embodiments, the optical detector is located off-axis from the energy source. In some embodiments, the optical detector is configured to receive only the first reflection of the first laser or only the second reflection of the second laser from the first location or the second location, respectively. For example, in some embodiments, the optical detector is configured to receive the laser of the first and second lasers that corresponds to a particular polarization state (such as an s-polarization or p-polarization state). In some embodiments, the optical detector is configured to generate only the first reflection signal or the second reflection signal. For example, in some embodiments, the optical detector is configured to generate only the reflection signal of the first and second reflection signals that corresponds to a particular polarization state (such as an s-polarization or p-polarization state).

In the example shown, the system comprises a controller 170. In some embodiments, the controller is configured to receive the first reflection signal from the detector. In some embodiments, the controller is configured to receive the second reflection signal from the detector. In some embodiments, the controller is configured to receive only the first reflection signal or the second reflection signal. For example, in some embodiments, the controller is configured to receive only the reflection signal of the first and second reflection signals that corresponds to a particular polarization state (such as an s-polarization or p-polarization state).

In some embodiments, the controller is configured to determine a first height and/or a first position of the first location from the first reflection signal. In some embodiments, the controller is configured to determine a second height and/or a second position of the second location from the second reflection signal.

In some embodiments, the controller is configured to determine the first height or the second height by comparing the first reflection signal or the second reflection signal, respectively, to a calibration curve. In some embodiments, the calibration curve relates the position of a reflection signal on the optical detector to a height on the part. In some embodiments, a change in the height of the part produces a change in the pixels of the optical detector (referred to herein as a “detector location”) that receive the first and/or second reflections of the first and/or second lasers from the part. As a result, in some embodiments, different heights and/or positions correspond to shifts of the reflection signal across the optical detector. Thus, in some embodiments, the first height and/or the second height is determined by determining the detector location of the first reflection signal or the second reflection signal, respectively, and comparing the results with a calibration curve. The shift of the reflection signal across the optical detector is further discussed in Example 1.

In some embodiments, the calibration curve is constructed as follows. First, the detector locations associated with known heights are determined. Second, a line is fit to the detector locations associated with each known height. Third, the lines are extrapolated to a “vanishing point” at which the lines substantially intersect. Fourth, an angle between the detector location and the vanishing point is determined for each known height. Fifth, the angles are plotted against the known heights and a polynomial function is fit to the results. The line fitting, extrapolation, vanishing point, and angles are discussed further in Example 1.

In some embodiments, once the calibration curve has been obtained, the first height is determined by comparing the detector location associated with the first reflection signal with the calibration curve. In some embodiments, the second height is determined by comparing the detector location associated second the first reflection signal with the calibration curve.

In some embodiments, a non-linear correction is applied to reduce non-idealities in the determination of the first height or the second height. In some embodiments, the calibration curve obtained from the procedure discussed herein can be improved by compensating for the non-telecentric nature of the system 100 described herein. Under non-telecentric conditions, the shifts of the reflection signals may be non-linear, while the vanishing point approach described herein may assume linearity. In some embodiments, this non-linearity is compensated for by determining errors associated with the measurement of each known height. In some embodiments, a non-linear function is fitted to the errors. In some embodiments, the non-linear function comprises a quadratic function. In some embodiments, the non-linear function is applied to correct for errors associated with the non-telecentric nature of the system. The non-linear correction is discussed further in Example 1.

In some embodiments, once the non-linear correction has been obtained, the first height is determined by applying the non-linear correction to the first height that was determined using the calibration curve. In some embodiments, the first height is determined by applying the non-linear correction to the first height that was determined using the calibration curve.

In some embodiments, the first height or the second height is determined with an accuracy of at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, or more. In some embodiments, the first height or the second height is determined with an accuracy of at most about 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In some embodiments, the first height or the second height is determined with an accuracy that is within a range defined by any two of the preceding values.

In some embodiments, the controller is configured to determine a first position of the first location and/or a second position of the second location. In some embodiments, the field of view (FOV) to which the optical detector is sensitive changes as the height of the part changes. In some embodiments, the FOV changes due to changes in magnification or changes in the origin. In some embodiments, such changes are compensated to determine the first position or the second position. In some embodiments, a grid image or a checkerboard pattern is used to construct a coordinate mapping from measured pixel locations on the optical detector to inferred locations on the part. In some embodiments, a known height is measured at a known location and measured pixel locations on the optical detector are collected. In some embodiments, a 3×3 transformation matrix is then constructed to correct for the FOV changes described herein. In some embodiments, this process is repeated for a series of known heights, yielding a series of 3×3 transformation matrices. In some embodiments, the coefficients of the series of 3×3 transformation matrices are fit to a linear function or a polynomial function. In some embodiments, a 3×3 transformation matrix is thus generated for any height. In some embodiments, the first position or the second position are determined based upon an associated height measurement, as described herein. The determination of the first position or the second position is discussed further in Example 2.

In some embodiments, the first position or the second position is determined with an accuracy of at least about 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, or more. In some embodiments, the first position or the second position is determined with an accuracy of at most about 50 μm, 45 μm, 40 μm, 35 μm, 30 μm, 25 μm, 20 μm, 15 μm, 10 μm, 9 μm, 8 μm, 7 μm, 6 μm, 5 μm, 4 μm, 3 μm, 2 μm, 1 μm, or less. In some embodiments, the first position or the second position is determined with an accuracy that is within a range defined by any two of the preceding values.

In some embodiments, the system further comprises a melt pool detector (not shown in FIG. 1). In some embodiments, the melt pool detector is configured to receive melt pool radiation (such as optical radiation) from the melt pool. In some embodiments, the melt pool detector is configured to generate a melt pool radiation signal from the melt pool radiation. In some embodiments, the controller is further configured to receive the melt pool radiation signal. In some embodiments, the controller is further configured to determine a melt pool height (and/or a melt pool position) based on the melt pool radiation signal. In some embodiments, the optical detector is configured to receive the melt pool radiation from the melt pool and to generate the melt pool radiation signal therefrom.

FIGS. 2, 3, and 4 show three different laser sources configured to generate the first and second lasers 152 and 156, respectively.

FIG. 2 shows a schematic depicting a first exemplary laser source 200 for use in combination with the exemplary system 100 for measuring layer topography in a 3D printing process. In the example shown, the laser source 200 comprises a single laser source 210. In some embodiments, the single laser source is configured to generate a single laser 212.

In the example shown, the laser source 200 comprises a beamsplitter 220. In some embodiments, the beamsplitter is configured to split the single laser 212 into the first laser 152 and the second laser 156. In some embodiments, the beamsplitter comprises a polarizing beamsplitter. In some embodiments, the polarizing beamsplitter is configured to impact p-polarization or s-polarization to the first laser or the second laser. In some embodiments, the beamsplitter comprises a beam displacer. In some embodiments, the beam displacer comprises a Wollaston prism, a Rochon prism, a calcite beam displacer, an yttrium vanadate (YVO₄) beam displacer, or a Savart plate.

In the example shown, the laser source 200 comprises a polarization element 230. In the example shown, the polarization element is located between the single laser source and the beamsplitter.

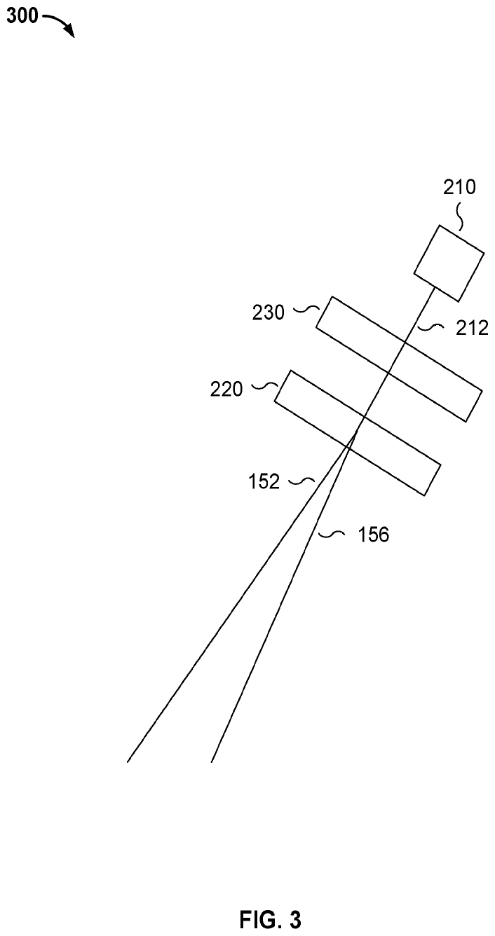

FIG. 3 shows a schematic depicting a second exemplary laser source 300 for use in combination with the exemplary system 100 for measuring layer topography in a 3D printing process. In the example shown, the laser source 300 comprises a single laser source 210. In some embodiments, the single laser source is configured to generate a single laser 212.

In the example shown, the laser source 300 comprises a beamsplitter 220. In some embodiments, the beamsplitter is configured to split the single laser 212 into the first laser 152 and the second laser 156. In some embodiments, the beamsplitter comprises a polarizing beamsplitter. In some embodiments, the polarizing beamsplitter is configured to impact p-polarization or s-polarization to the first laser or the second laser. In some embodiments, the beamsplitter comprises any beam displacer described herein.

In the example shown, the laser source 300 comprises a polarization element 230. In the example shown, the beamsplitter is located between the single laser source and the beamsplitter. Thus, in comparison with laser source 200 of FIG. 2, laser source 300 of FIG. 3 juxtaposes the position of the beamsplitter and the polarization element.

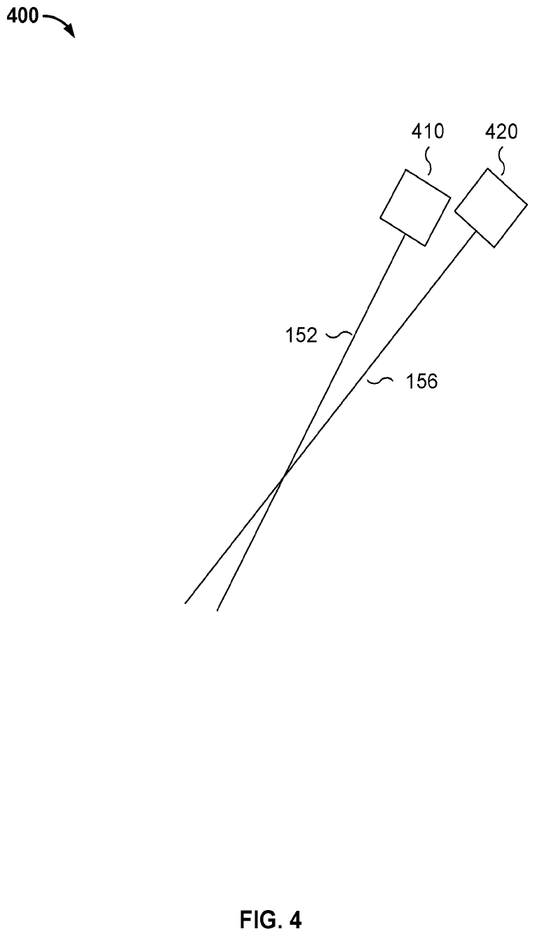

FIG. 4 shows a schematic depicting a third exemplary laser source 400 for use in combination with the exemplary system 100 for measuring layer topography in a 3D printing process. In the example shown, the laser source 400 comprises a first laser source 410. In some embodiments, the first laser source is configured to generate a first laser 152.

In the example shown, the laser source 400 comprises a second laser source 420. In some embodiments, the second laser source is configured to generate a second laser 156.

Although depicted in FIG. 1 as directing only first and second lasers to the first and second locations, respectively, the laser source 150 described herein may also be configured to direct a third laser to a third location (not shown in FIG. 1). In some embodiments, the third location is orthogonal to the scanning direction. In some embodiments, the third location is to the side of the melt pool. In some embodiments, the third location is a third distance to the side of the melt pool. In some embodiments, the third distance is at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1,000 mm, or more. In some embodiments, the third distance is at most about 1,000 mm, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In some embodiments, the third distance is within a range defined by any two of the preceding values. In some embodiments, the laser source comprises any of laser sources 200, 300, 400, 500, 600, or 700 described herein with respect to FIG. 2, 3, 4, 5, 6, or 7, respectively. In some embodiments, the laser source 150 described herein is also be configured to direct a fourth laser to a fourth location (not shown in FIG. 1). In some embodiments, the fourth location is orthogonal to the scanning direction. In some embodiments, the fourth location is to the side of the melt pool opposite the third location. In some embodiments, the fourth location is a fourth distance to the side of the melt pool opposite the third location. In some embodiments, the fourth distance is at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1,000 mm, or more. In some embodiments, the fourth distance is at most about 1,000 mm, 900 mm, 800 mm, 700 mm, 600 mm, 500 mm, 400 mm, 300 mm, 200 mm, 100 mm, 90 mm, 80 mm, 70 mm, 60 mm, 50 mm, 40 mm, 30 mm, 20 mm, 10 mm, 9 mm, 8 mm, 7 mm, 6 mm, 5 mm, 4 mm, 3 mm, 2 mm, 1 mm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. In some embodiments, the fourth distance is within a range defined by any two of the preceding values.

In some embodiments, the optical detector 160 is further configured to receive a third reflection of the third laser from the third location. In some embodiments, the third reflection comprises a third laser triangulation reflection. In some embodiments, the optical detector is configured to generate a third reflection from the third reflection. In some embodiments, the third reflection signal comprises a third laser triangulation signal. In some embodiments, the optical detector is configured to receive a fourth reflection of the fourth laser from the fourth location. In some embodiments, the fourth reflection comprises a fourth laser triangulation reflection. In some embodiments, the optical detector is configured to generate a fourth reflection signal from the fourth reflection. In some embodiments, the fourth reflection signal comprises a fourth laser triangulation signal. In some embodiments, the optical detector is configured to receive only one, two, or three of the first reflection, the second reflection, the third reflection, and the fourth reflection from the first location, the second location, the third location, or the fourth location, respectively. For example, in some embodiments, the optical detector is configured to receive only one, two, or three of the first, second, third, and fourth reflections that correspond to a particular polarization state (such as an s-polarization or p-polarization state). In some embodiments, the optical detector is configured to generate only one, two, or three of the first reflection signal, the second reflection signal, the third reflection signal, and the fourth reflection signal. For example, in some embodiments, the optical detector is configured to generate only one, two, or three of the reflection signals of the first, second, third, and fourth reflection signals that correspond to a particular polarization state (such as an s-polarization or p-polarization state).

Although depicted as comprising a single optical detector in FIG. 1, the system 100 can comprise any number of optical detectors. For instance, the system may comprise at least about 1, 2, 3, 4, 5, 6, 7, 8, 9, 10, or more optical detectors. The system may comprise at most about 10, 9, 8, 7, 6, 5, 4, 3, 2, or 1 optical detectors. The system may comprise a number of optical detectors that is within a range defined by any two of the preceding values. In some embodiments, the optical detectors are arranged at different off-axis viewing angles. In some embodiments, the use of multiple optical detectors at different off-axis angles reduces the blind spots to which a single optical detector may be susceptible.

In some embodiments, the controller 170 is further configured to receive the third reflection signal from the detector. In some embodiments, the controller is configured to receive the fourth reflection signal from the detector. In some embodiments, the controller is configured to receive only one, two, or three of the first reflection signal, the second reflection signal, the third reflection signal, and the fourth reflection signal. For example, in some embodiments, the controller is configured to receive only one, two, or three of the reflection signals of the first, second, third, and fourth reflection signals that correspond to a particular polarization state (such as an s-polarization or p-polarization state).

In some embodiments, the controller is configured to determine a third height and/or a third position of the third location from the third reflection signal. In some embodiments, the controller is configured to determine a fourth height and/or a fourth position of the fourth location from the fourth reflection signal. In some embodiments, the third height or the fourth height are determined using the calibration curves described herein with respect to FIG. 1 or with respect to Example 1. In some embodiments, the third position or the fourth position are determined using the 3×3 transformation matrices described herein with respect to FIG. 1 or with respect to Example 2.

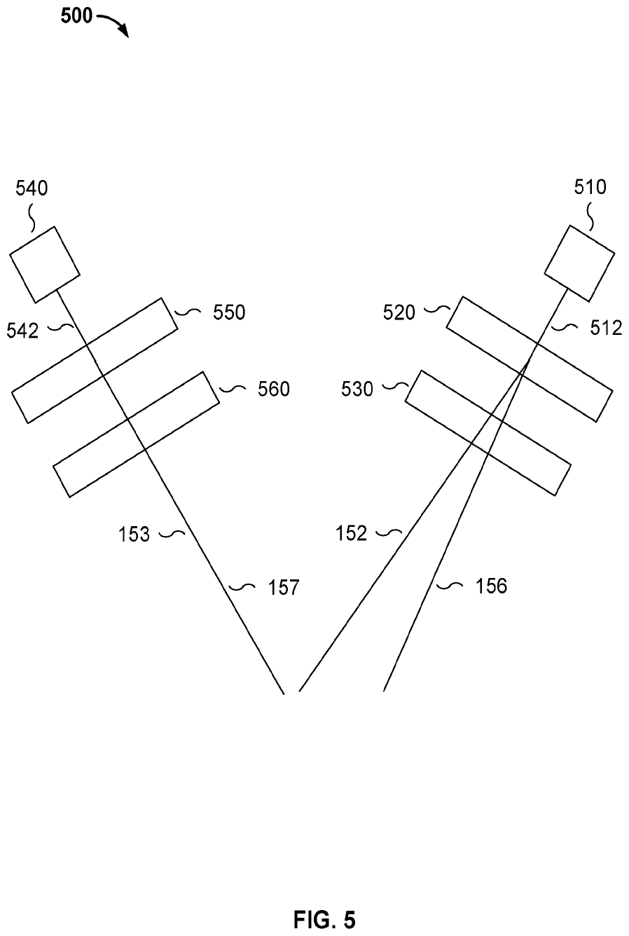

FIGS. 5, 6, and 7 show three different laser sources configured to generate the first and second lasers 152 and 156, respectively, as well as third and fourth lasers 153 and 157, respectively.

FIG. 5 shows a schematic depicting a fourth exemplary laser source 500 for use in combination with the exemplary system 100 for measuring layer topography in a 3D printing process. In the example shown, the laser source 500 comprises a single parallel laser source 510. In some embodiments, the single parallel laser source is configured to generate a single parallel laser 512. In the example shown, the nomenclature “parallel” is used to indicate that the single parallel laser is to be directed to the first and second locations along the scanning direction.

In the example shown, the laser source 500 comprises a first beamsplitter 520. In some embodiments, the first beamsplitter is configured to split the single parallel laser 512 into the first laser 152 and the second laser 156. In some embodiments, the first beamsplitter comprises a polarizing beamsplitter. In some embodiments, the polarizing beamsplitter is configured to impact p-polarization or s-polarization to the first laser or the second laser. In some embodiments, the first beamsplitter comprises any beam displacer described herein.

In the example shown, the laser source 500 comprises a first polarization element 530. In the example shown, the first polarization element is located between the single parallel laser source and the first beamsplitter.

In the example shown, the laser source 500 comprises a single perpendicular laser source 540. In some embodiments, the single perpendicular laser source is configured to generate a single perpendicular laser 542. In the example shown, the nomenclature “perpendicular” is used to indicate that the single perpendicular laser is to be directed to the third and fourth locations perpendicular to the scanning direction.

In the example shown, the laser source 500 comprises a second beamsplitter 550. In some embodiments, the second beamsplitter is configured to split the single perpendicular laser 542 into the third laser 153 and the fourth laser 157. In the view shown, the third and fourth lasers are depicted as overlapping. However, the third and fourth lasers should be interpreted as being partially directed into and out of the page, respectively. In some embodiments, the second beamsplitter comprises a polarizing beamsplitter. In some embodiments, the polarizing beamsplitter is configured to impact p-polarization or s-polarization to the third laser or the fourth laser. In some embodiments, the second beamsplitter comprises any beam displacer described herein.

In the example shown, the laser source 500 comprises a second polarization element 560. In the example shown, the second polarization element is located between the single perpendicular laser source and the second beamsplitter.

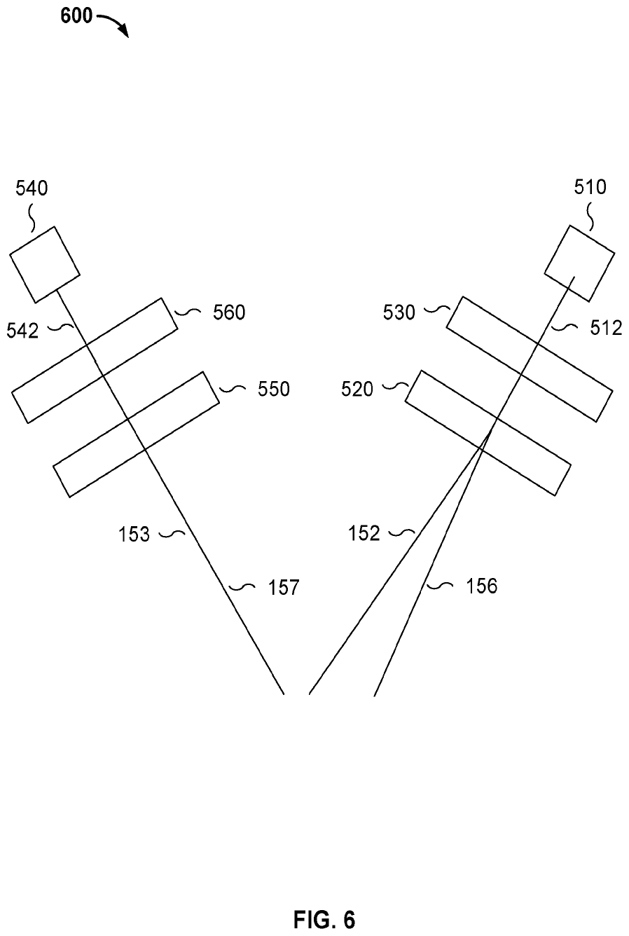

FIG. 6 shows a schematic depicting a fifth exemplary laser source 600 for use in combination with the exemplary system 100 for measuring layer topography in a 3D printing process. In the example shown, the laser source 600 comprises a single parallel laser source 510. In some embodiments, the single parallel laser source is configured to generate a single parallel laser 512. In the example shown, the nomenclature “parallel” is used to indicate that the single parallel laser is to be directed to the first and second locations along the scanning direction.

In the example shown, the laser source 600 comprises a first beamsplitter 520. In some embodiments, the first beamsplitter is configured to split the single parallel laser 512 into the first laser 152 and the second laser 156. In some embodiments, the first beamsplitter comprises a polarizing beamsplitter. In some embodiments, the polarizing beamsplitter is configured to impact p-polarization or s-polarization to the first laser or the second laser. In some embodiments, the first beamsplitter comprises any beam displacer described herein.

In the example shown, the laser source 600 comprises a first polarization element 530. In the example shown, the first beamsplitter is located between the single parallel laser source and the first beamsplitter. Thus, in comparison with laser source 500 of FIG. 5, laser source 600 of FIG. 6 juxtaposes the position of the first beamsplitter and the first polarization element.

In the example shown, the laser source 600 comprises a single perpendicular laser source 540. In some embodiments, the single perpendicular laser source is configured to generate a single perpendicular laser 542. In the example shown, the nomenclature “perpendicular” is used to indicate that the single perpendicular laser is to be directed to the third and fourth locations perpendicular to the scanning direction.

In the example shown, the laser source 600 comprises a second beamsplitter 550. In some embodiments, the second beamsplitter is configured to split the single perpendicular laser 542 into the third laser 153 and the fourth laser 157. In the view shown, the third and fourth lasers are depicted as overlapping. However, the third and fourth lasers should be interpreted as being partially directed into and out of the page, respectively. In some embodiments, the second beamsplitter comprises a polarizing beamsplitter. In some embodiments, the polarizing beamsplitter is configured to impact p-polarization or s-polarization to the third laser or the fourth laser. In some embodiments, the second beamsplitter comprises any beam displacer described herein.

In the example shown, the laser source 600 comprises a second polarization element 560. In the example shown, the second beamsplitter is located between the single perpendicular laser source and the second beamsplitter. Thus, in comparison with laser source 500 of FIG. 5, laser source 600 of FIG. 6 juxtaposes the position of the second beamsplitter and the second polarization element.

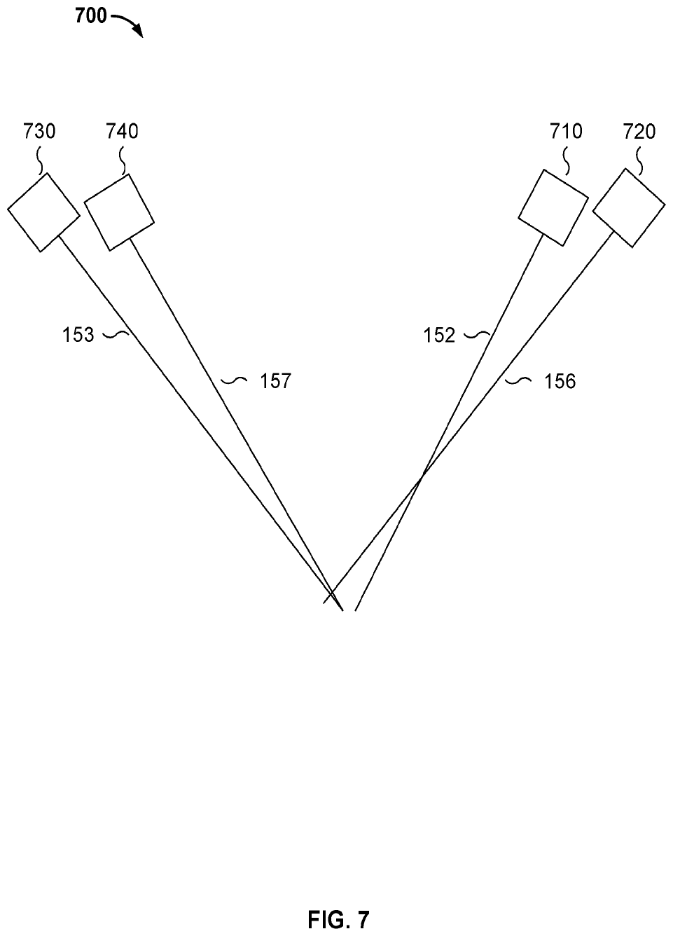

FIG. 7 shows a schematic depicting a sixth exemplary laser source 700 for use in combination with the exemplary system for measuring layer topography in a 3D printing process. In the example shown, the laser source 700 comprises a first laser source 710. In some embodiments, the first laser source is configured to generate a first laser 152.

In the example shown, the laser source 700 comprises a second laser source 720. In some embodiments, the second laser source is configured to generate a second laser 156.

In the example shown, the laser source 700 comprises a third laser source 730. In some embodiments, third first laser source is configured to generate a third laser 153.

In the example shown, the laser source 700 comprises a fourth laser source 740. In some embodiments, the fourth laser source is configured to generate a fourth laser 157.

In the view shown, the third and fourth lasers are depicted as being directed along the same plane. However, the third and fourth lasers should be interpreted as being partially directed into and out of the page, respectively.

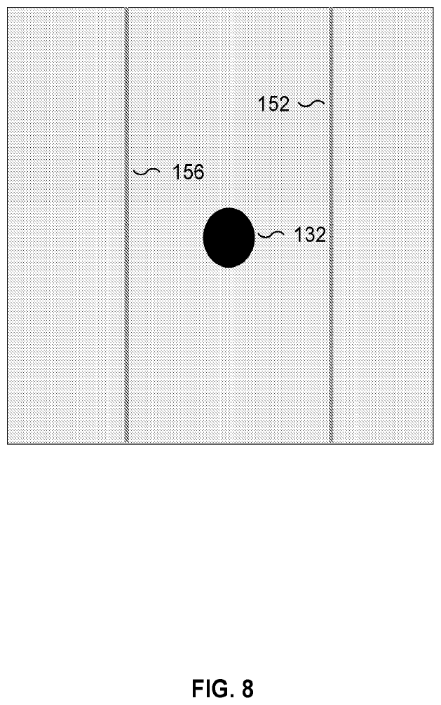

FIG. 8 shows a diagram of two lasers that can be used to measure surface heights at one or two locations in the vicinity of a melt pool on a layer of a 3D printed part. In the example shown, the view is looking down upon the layer being printed. At a given point in the 3D printing process, a melt pool 132 is formed, as described herein. In the example shown, the energy source is assumed to be moving to the right. In the example shown, the first laser 152 is located to the right of (ahead of) the melt pool. In the example shown, the second laser 156 is located to the left of (behind) the melt pool.

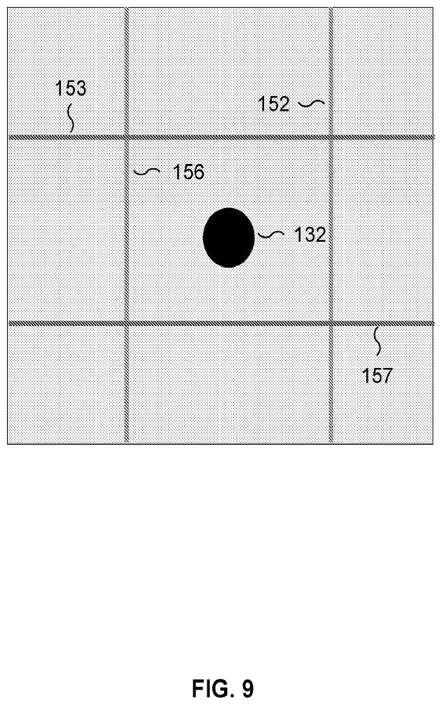

FIG. 9 shows a diagram of four lasers that can be used to measure surface heights at one, two, three, or four locations in the vicinity of a melt pool on a layer of a 3D printed part. In the example shown, the view is looking down upon the layer being printed. At a given point in the 3D printing process, a melt pool 132 is formed, as described herein. In the example shown, the energy source is assumed to be moving to the right. In the example shown, the first laser 152 is located to the right of (ahead of) the melt pool. In the example shown, the second laser 156 is located to the left of (behind) the melt pool. In the example shown, the third laser 153 is located above the melt pool, perpendicular to the scanning direction. In the example shown, the fourth laser 157 is located below the melt pool, perpendicular to the scanning direction.

As shown in FIG. 9, in some embodiments, the third laser intersects the first laser. In some embodiments, the third laser intersects the second laser. In some embodiments, the fourth laser intersects the first laser. In some embodiments, the fourth laser intersects the second laser. In some embodiments, the third laser is orthogonal to the first laser. In some embodiments, the third laser is orthogonal to the second laser. In some embodiments, the fourth laser is orthogonal to the first laser. In some embodiments, the fourth laser is orthogonal to the second laser. In some embodiments, the melt pool is surrounded by the first laser, the second laser, the third laser, and/or the fourth laser. In some embodiments, the lasers surrounding the melt pool form an approximately rectangular, square, diamond, or triangular shape around the melt pool.

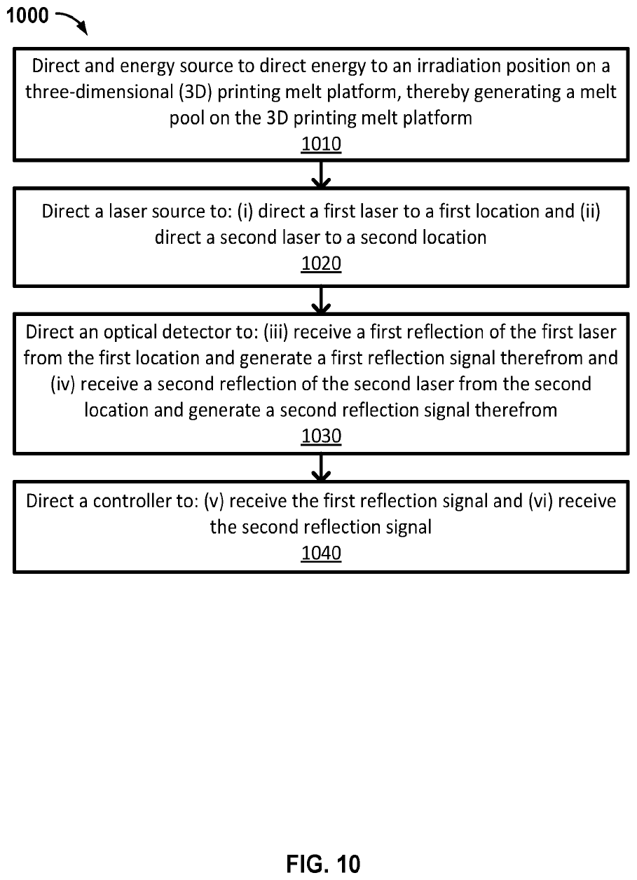

FIG. 10 shows a flowchart depicting an exemplary method 1000 for measuring layer topography in a 3D printing process. In the example shown, an energy source is directed to direct energy to an irradiation position on a 3D printing melt platform (or on a table or on a production located thereon) at 1010. The energy thereby generates a melt pool on the 3D printing melt platform (or on the table or on the production located thereon), as described herein.

At 1020, a laser source is directed to: direct a first laser to a first location along the scanning direction, the first location being a first distance ahead of the melt pool and direct a second laser to a second location along the scanning direction, the second location being a second distance behind the melt pool, as described herein. In some embodiments, the first laser is a first laser and/or the second laser is a second laser, as described herein. In some embodiments, the first laser is a first point laser and/or the second laser is a second point laser, as described herein. In some embodiments, the first laser and the second laser are irradiated on the production during the 3D printing process. In some embodiments, the laser source comprises a single laser source configured to generate a single laser and a beamsplitter configured to split the single laser into the first laser and the second laser. In some embodiments, the beamsplitter comprises a polarizing beamsplitter. In some embodiments, the beamsplitter comprises a beam displacer. In some embodiments, the laser source further comprises a polarization element. In some embodiments, the polarization element is located between the single laser source and the beamsplitter. In some embodiments, the beamsplitter is located between the single laser source and the polarization element. In some embodiments, the laser source comprises a first laser source configured to generate the first laser and a second laser source configured to generate the second laser.

At 1030, at least one optical detector is directed to: receive a first reflection of the first laser from the first location and generate a first reflection signal therefrom and receive a second reflection of the second laser from the second location and generate a second reflection signal therefrom, as described herein. In some embodiments, the first reflection signal is a first laser triangulation signal and/or the second reflection signal is a second laser triangulation signal.

At 1040, a controller is directed to: receive the first reflection signal and receive the second reflection signal, as described herein. In some embodiments, the irradiation position is located between the first location and the second location. In some embodiments, the controller is further directed to determine a first height and/or a first position of the first location based on the first reflection signal, as described herein. In some embodiments, the controlled is further directed to determine a second height and/or a second position of the second location based on the second reflection signal, as described herein.

In some embodiments, the method further comprises directing a scanner to move the table and/or the energy to scan the irradiation position on the production to thereby change a relative position between the energy and the production during the 3D printing process.

In some embodiments, the method further comprises directing a melt pool detector to receive a melt pool radiation from the melt pool and to generate a melt pool radiation signal therefrom. In some embodiments, the method further comprises directing the controller to receive the melt pool radiation signal and to determine a melt pool height and/or a melt pool position based on the melt pool radiation signal.

In some embodiments, the method further comprises directing the optical detector to receive a melt pool radiation from the melt pool and to generate a melt pool radiation signal therefrom. In some embodiments, the method further comprises directing the controller to receive the melt pool radiation signal and to determine a melt pool height and/or a melt pool position based on the melt pool radiation signal.

In some embodiments, the method further comprises directing the laser source to: direct a third laser to a third location and direct a fourth laser to a fourth location. In some embodiments, the third laser intersects the first laser and/or the second laser and/or the fourth laser intersects the first laser and/or the second laser. In some embodiments, the third laser is orthogonal to the first laser and/or the second laser and/or wherein the fourth laser is orthogonal to the first laser and/or the second laser. In some embodiments, the melt pool is surrounded by the first laser, the second laser, the third laser, and the fourth laser. In some embodiments, the laser source comprises: a single parallel laser source configured to generate a single parallel laser and a first beamsplitter configured to split the single parallel laser into the first laser and the second laser and a single orthogonal laser source configured to generate a single orthogonal laser and a second beamsplitter configured to split the single orthogonal laser into the third laser and the fourth laser. In some embodiments, the first beamsplitter or the second beamsplitter comprises a polarizing beamsplitter. In some embodiments, the first beamsplitter or the second beamsplitter comprises a beam displacer. In some embodiments, the laser source further comprises a first polarization element or a second polarization element. In some embodiments, the first polarization element is located between the single parallel laser source and the first beamsplitter or the second polarization element is located between the single perpendicular laser source and the second beamsplitter. In some embodiments, the first beamsplitter is located between the single parallel laser source and the first polarization element or the second beamsplitter is located between the single perpendicular laser source and the second polarization element. In some embodiments, the laser source comprises a first laser source configured to generate the first laser, a second laser source configured to generate the second laser, a third laser source configured to generate the third laser, and a fourth laser source configured to generate the fourth laser.

In some embodiments, the method further comprises directing the optical detector to: receive a third reflection of the third laser from the third location and generate a third laser reflection signal therefrom and receive a fourth reflection of the fourth laser upon reflection from the fourth location and generate a fourth laser reflection signal therefrom.

In some embodiments, the method further comprises directing the controller to: receive the third reflection signal and determine a third height and/or a third position of the production at the third location therefrom and receive the fourth reflection signal and determine a fourth height and/or a fourth position of production at the fourth location therefrom. In some embodiments, the optical detector is located off-axis from the energy source. In some embodiments, a fold mirror is located between the table and the optical detector. In some embodiments, the energy source comprises an optical energy source and the energy comprises optical energy. In some embodiments, the optical energy source comprises a laser energy source and the optical energy comprises laser energy.

In some embodiments, method 1000, or any one or more of operations 1010, 1020, 1030, and 1040, is repeated a plurality of times at a plurality of different first locations and second locations to generate a height map of the production. In some embodiments, method 1000, or any one or more of operations 1010, 1020, 1030, and 1040, is repeated at least about 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more times. In some embodiments, method 1000, or any one or more of operations 1010, 1020, 1030, and 1040, is repeated at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 times. In some embodiments, method 1000, or any one or more of operations 1010, 1020, 1030, and 1040, is repeated a number of times that is within a range defined by any two of the preceding values.

The method 1000, or any one or more of operations 1010, 1020, 1030, and 1040, may be implemented using any of the systems described herein, such as system 100 described herein with respect to FIG. 1 or any of laser sources 200, 300, 400, 500, 600, or 700 described herein with respect to FIG. 2, 3, 4, 5, 6, or 7 described herein.

Additionally, systems are disclosed that can be used to perform the method 1000 of FIG. 10, or any of operations 1010, 1020, 1030, and 1040. In some embodiments, the systems comprise one or more processors and memory coupled to the one or more processors. In some embodiments, the one or more processors are configured to implement one or more operations of method 1000, or any one or more of operations 1010, 1020, 1030, and 1040. In some embodiments, the memory is configured to provide the one or more processors with instructions corresponding to the operations of method 1000, or any one or more of operations 1010, 1020, 1030, and 1040. In some embodiments, the instructions are embodied in a tangible computer readable storage medium.

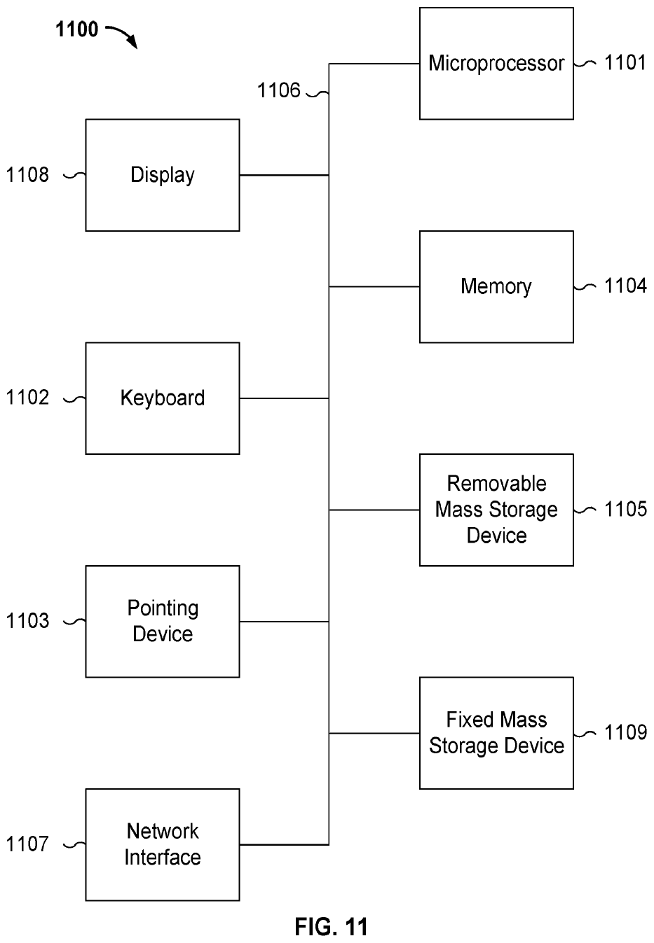

FIG. 11 is a block diagram of a computer system 1100 used in some embodiments to perform portions of methods for improved heating in a 3D printing process described herein (such as any one or more of operations 1010, 1020, 1030, and 1040 of method 1000 as described herein with respect to FIG. 10). In some embodiments, the computer system may be utilized as a component in systems for observation of a 3D printing process described herein. FIG. 11 illustrates one embodiment of a general purpose computer system. Other computer system architectures and configurations can be used for carrying out the processing of the present invention. Computer system 1100, made up of various subsystems described below, includes at least one microprocessor subsystem 1101. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 1100. Using instructions retrieved from memory 1104, the microprocessor subsystem controls the reception and manipulation of input data, and the output and display of data on output devices.

The microprocessor subsystem 1101 is coupled bi-directionally with memory 1104, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 1104 may include any suitable computer-readable storage media, described below, depending on whether, for example, data access needs to be bi-directional or uni-directional. The microprocessor subsystem 1101 can also directly and very rapidly retrieve and store frequently needed data in a cache memory (not shown).

A removable mass storage device 1105 provides additional data storage capacity for the computer system 1100, and is coupled either bi-directionally (read/write) or uni-directionally (read only) to microprocessor subsystem 1101. Storage 1105 may also include computer-readable media such as magnetic tape, flash memory, signals embodied on a carrier wave, PC-CARDS, portable mass storage devices, holographic storage devices, and other storage devices. A fixed mass storage 1109 can also provide additional data storage capacity. The most common example of mass storage 1109 is a hard disk drive. Mass storage 1105 and 1109 generally store additional programming instructions, data, and the like that typically are not in active use by the processing subsystem. It will be appreciated that the information retained within mass storage 1105 and 1109 may be incorporated, if needed, in standard fashion as part of primary storage 1104 (e.g. RAM) as virtual memory.

In addition to providing processing subsystem 1101 access to storage subsystems, bus 1106 can be used to provide access other subsystems and devices as well. In the described embodiment, these can include a display monitor 1108, a network interface 1107, a keyboard 1102, and a pointing device 1103, as well as an auxiliary input/output device interface, a sound card, speakers, and other subsystems as needed. The pointing device 1103 may be a mouse, stylus, track ball, or tablet, and is useful for interacting with a graphical user interface.

The network interface 1107 allows the processing subsystem 1101 to be coupled to another computer, computer network, or telecommunications network using a network connection as shown. Through the network interface 1107, it is contemplated that the processing subsystem 1101 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 1101 can be used to connect the computer system 1100 to an external network and transfer data according to standard protocols. That is, method embodiments of the present invention may execute solely upon processing subsystem 1101, or may be performed across a network such as the Internet, intranet networks, or local area networks, in conjunction with a remote processing subsystem that shares a portion of the processing. Additional mass storage devices (not shown) may also be connected to processing subsystem 1101 through network interface 1107.

An auxiliary I/O device interface (not shown) can be used in conjunction with computer system 1100. The auxiliary I/O device interface can include general and customized interfaces that allow the processing subsystem 1101 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 11 is but an example of a computer system suitable for use with the invention. Other computer systems suitable for use with the invention may include additional or fewer subsystems. In addition, bus 1106 is illustrative of any interconnection scheme serving to link the subsystems. Other computer architectures having different configurations of subsystems may also be utilized.

### EXAMPLES

### Example 1: Height Determination

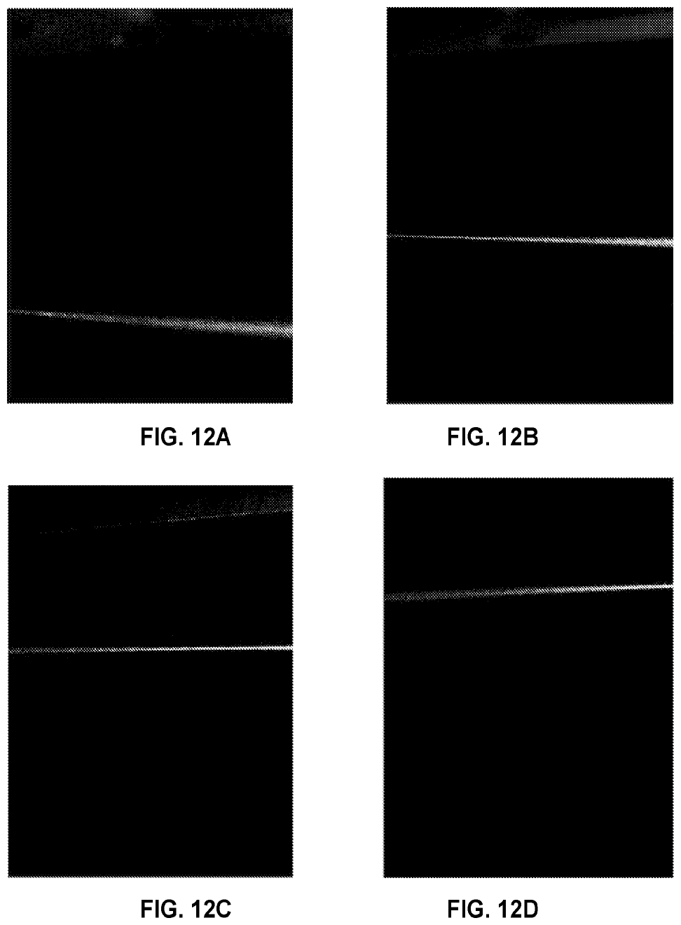

FIGS. 12A-D show an example of shifts of a laser triangulation signal across an optical detector with changing distance from a laser source to a location from which a laser is reflected. In FIGS. 12A-D, the optical detector viewed at a non-normal incidence.

FIG. 12A shows an example of a first shift associated with a first distance from the laser source to the location. The first distance was set by moving a process head on which the laser source was mounted to a location 0 millimeters (mm) away from the 3D printing melt platform. As shown in FIG. 12A, the laser was detected near the bottom edge of the optical detector.

FIG. 12B shows an example of a second shift associated with a second distance from the laser source to the location. The second distance was set by moving the process head to a location 10 mm away from the 3D printing melt platform. As shown in FIG. 12B, the laser was detected above the bottom edge of the optical detector and below the middle of the optical detector.

FIG. 12C shows an example of a third shift associated with a third distance from the laser source to the location. The third distance was set by moving the process head to a location 20 mm away from the 3D printing melt platform. As shown in FIG. 12C, the laser was detected below the top edge of the optical detector and above the middle of the optical detector.

FIG. 12D shows an example of a fourth shift associated with a fourth distance from the laser source to the location. As shown in FIG. 12D, the laser was detected near the top edge of the optical detector. The fourth distance was set by moving the process head to a location 30 mm away from the 3D printing melt platform. Thus, FIGS. 12A-12D show the upward shift of the laser with increasing distance from the laser source to the location from which the laser was reflected.

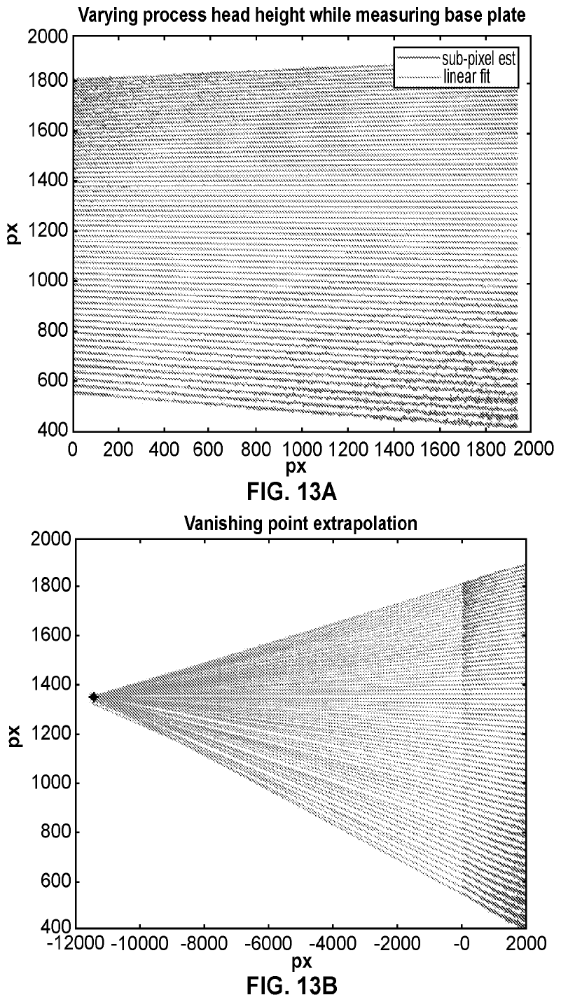

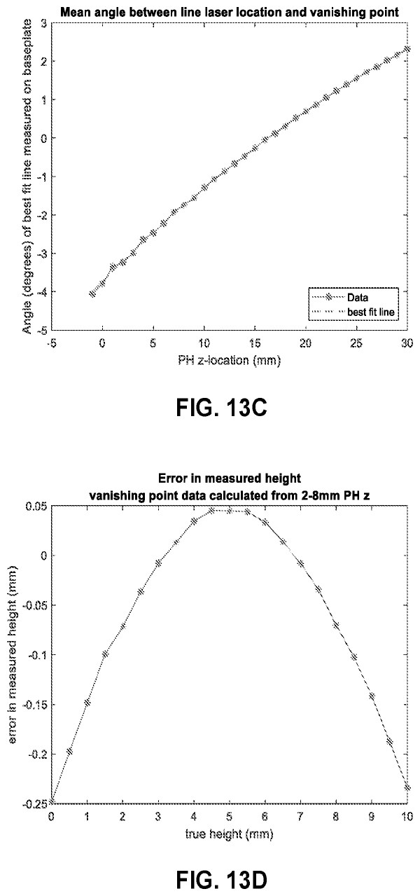

FIG. 13A shows an example of shifts associated with a variety of distances from the laser source, as well as linear fits associated with these shifts. In the example shown, the x-axis shows the optical detector horizontal pixel number and the y-axis shows the optical detector horizontal pixel number. The linear fits diverge from one another moving left to right across the optical detector. Thus, if the linear fits are extrapolated to the left, they ultimately substantially converge near a single point.

FIG. 13B shows an example of extrapolated shifts associated with the variety of distances from the laser source shown in FIG. 13A. In the example shown, a least-squares fitting procedure was used to determine the point (the vanishing point) in space (outside the FOV of the optical detector) where the linear fits would substantially converge if the optical detector had a larger FOV. In the example shown, the box from horizontal pixels 0 to 2000 and vertical pixels 400 to 2000 represents the data shown in FIG. 13A.

FIG. 13C shows an example of a calibration curve determined from the extrapolated shifts shown in FIG. 13B. For each of the variety of distances associated with the data shown in FIGS. 13A-B, an angle between the corresponding location of the laser on the optical detector and the vanishing point was determined. The angles were plotted against the distances and a polynomial function was fit to the results. As shown in FIG. 13C, the distance-angle relationship is well modeled by a low-order polynomial fit.

FIG. 13D shows an example of a non-linear correction applied to measurements associated with the calibration curve of FIG. 13C. As shown in FIG. 13D, the error was approximately quadratic with increasing heights.

### Example 2: Location Determination

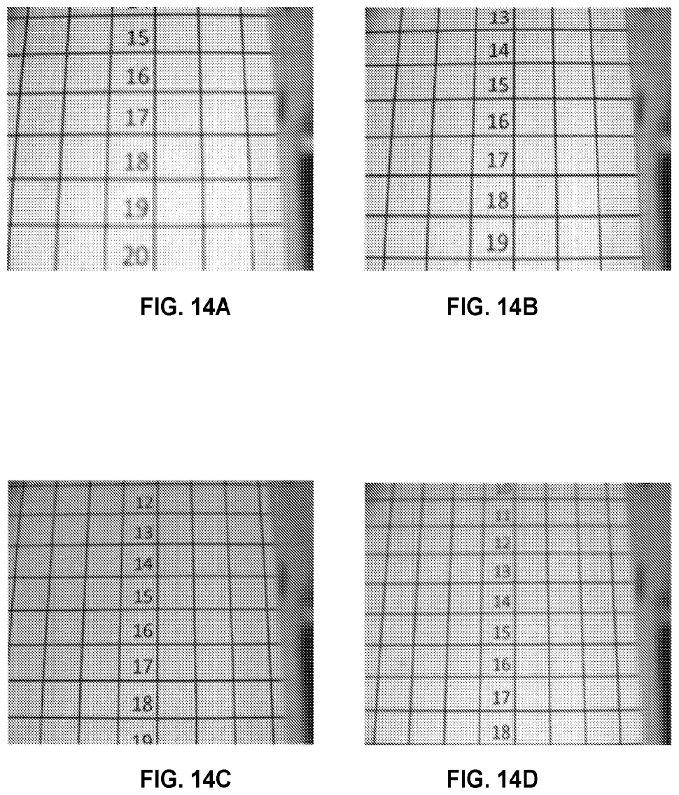

FIGS. 14A-D show an example of changing grid images associated with changing FOVs to which an optical detector is sensitive with changing distance from a laser source to a location from which a laser is reflected.

FIG. 14A shows an example of a first grid image associated with a first distance from the laser source to the location. The first distance was set by moving the process head to a location 0 mm away from the 3D printing melt platform.

FIG. 14B shows an example of a second grid image associated with a second distance from the laser source to the location. The second distance was set by moving the process head to a location 10 mm away from the 3D printing melt platform.

FIG. 14C shows an example of a third grid image associated with a third distance from the laser source to the location. The third distance was set by moving the process head to a location 20 mm away from the 3D printing melt platform.

FIG. 14D shows an example of a fourth image associated with a fourth distance from the laser source to the location. The fourth distance was set by moving the process head to a location 30 mm away from the 3D printing melt platform.

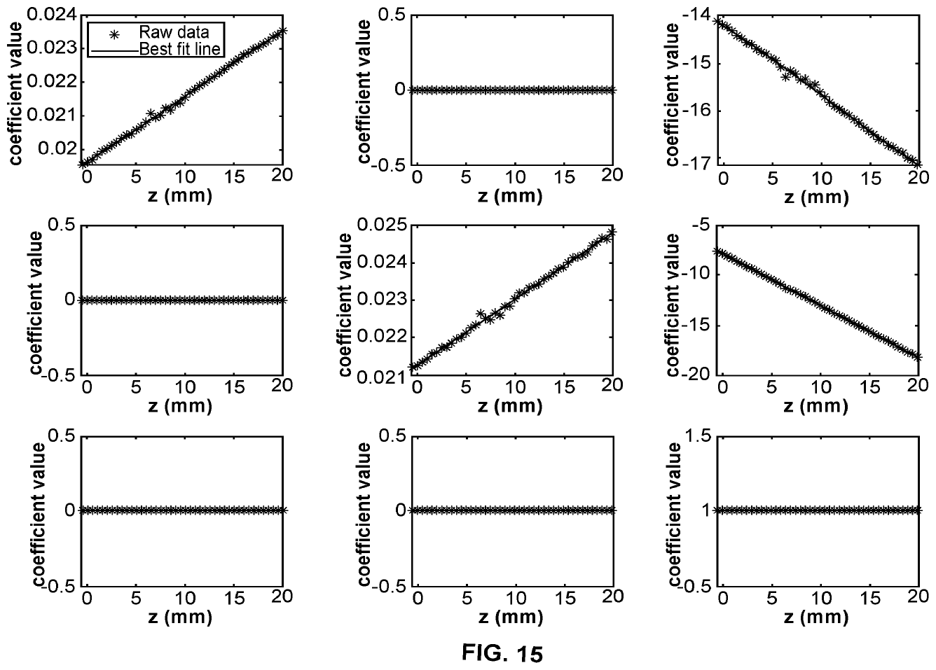

FIG. 15 shows an example of 3×3 transformation matrices associated with a variety of grid images. A variety of grid images were obtained at a variety of known distances. At each height, the bottom right corner of the “15” mark in the grid image was established as a global origin (0, 0). At each known distance, approximately 25 positions in the grid image were used to establish a transformation from measured pixel locations on the optical detector to inferred locations on the part. At the end of this procedure, 3×3 transformation matrices were constructed for each of the variety of known distances. Each element of the transformation matrices was fitted to a linear function.

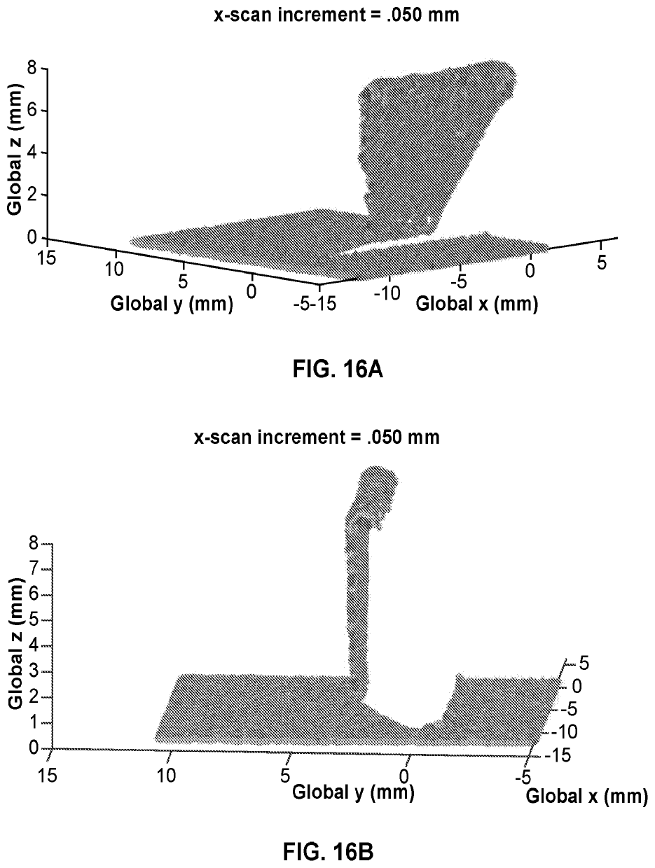

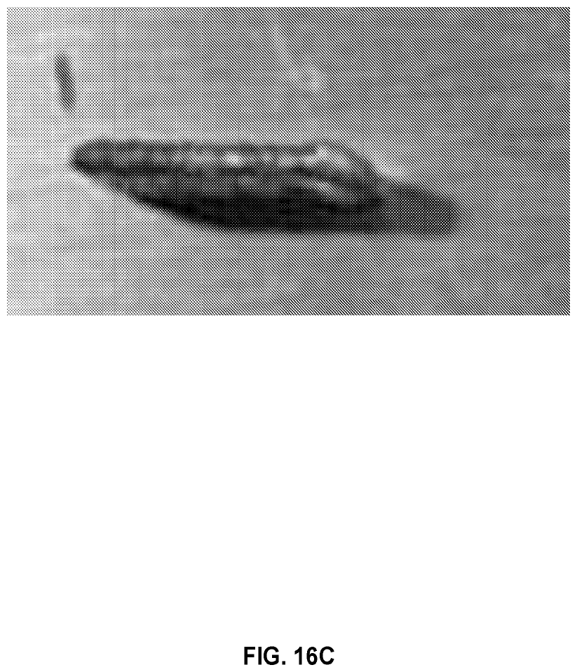

FIG. 16A shows an example of a first view of a height map associated with a test part and constructed using the systems and methods described herein. Gaps in the height map arose due to shadows cast by the part.

FIG. 16B shows an example of a second view of the height map. Gaps in the height map arose due to shadows cast by the part.

FIG. 16C shows the test part.

### RECITATION OF EMBODIMENTS

Embodiment 1. A system comprising:
a table configured to support a production of a 3D printed component during a 3D printing process;
an energy source configured to direct energy to an irradiation position during the 3D printing process, wherein the energy directed to the irradiation position is irradiated to the production, thereby generating a melt pool on the production;
a laser source configured to: direct a first laser to a first location and direct a second laser to a second location;
an optical detector configured to: receive a first reflection of the first laser from the first location and generate a first reflection signal therefrom and receive a second reflection of the second laser from the second location and generate a second reflection signal therefrom; and
a controller configured to: receive the first reflection signal and receive the second reflection signal;
wherein the irradiation position is between the first location and the second location.

Embodiment 2. The system of Embodiment 1, wherein the controller is further configured to: determine a first height and/or a first position of the production at the first location based on the first reflection signal and determine a second height and/or a second position of the production at the second location based on the second reflection signal.

Embodiment 3. The system of Embodiment 1 or 2, wherein the first laser is a first laser and/or wherein the second laser is a second laser.

Embodiment 4. The system of Embodiment 1 or 2, wherein the first laser is a first point laser and/or wherein the second laser is a second point laser.

Embodiment 5. The system of any one of Embodiments 1-4, further comprising: a scanner configured to move the table and/or the energy to scan the irradiation position on the production to thereby change a relative position between the energy and the production during the 3D printing process.

Embodiment 6. The system of Embodiment 5, wherein, with respect to a scanning direction of the energy, the first location is a first distance ahead of the melt pool and/or the second location is a second distance behind the melt pool.

Embodiment 7. The system of any one of Embodiments 1-6, wherein the first reflection signal is a first laser triangulation signal and/or wherein the second reflection signal is a second laser triangulation signal.

Embodiment 8. The system of any one of Embodiments 1-7, wherein the first laser and the second laser are irradiated on the production during the 3D printing process.

Embodiment 9. The system of any one of Embodiments 1-8, further comprising a melt pool detector configured to receive a melt pool radiation from the melt pool and to generate a melt pool radiation signal therefrom, wherein the controller is further configured to receive the melt pool radiation signal and to determine a melt pool height and/or a melt pool position based on the melt pool radiation signal.

Embodiment 10. The system of any one of Embodiments 1-8, wherein the optical detector is further configured to receive a melt pool radiation from the melt pool and to generate a melt pool radiation signal therefrom and wherein the controller is configured to receive the melt pool radiation signal and to determine a melt pool height and/or a melt pool position based on the melt pool radiation signal.

Embodiment 11. The system of any one of Embodiments 1-10, wherein the laser source comprises a single laser source configured to generate a single laser and a beamsplitter configured to split the single laser into the first laser and the second laser.

Embodiment 12. The system of Embodiment 11, wherein the beamsplitter comprises a polarizing beamsplitter.

Embodiment 13. The system of Embodiment 11 or 12, wherein the beamsplitter comprises a beam displacer.

Embodiment 14. The system of any one of Embodiments 11-13, wherein the laser source further comprises a polarization element.

Embodiment 15. The system of Embodiment 14, wherein the polarization element is located between the single laser source and the beamsplitter.

Embodiment 16. The system of Embodiment 14, wherein the beamsplitter is located between the single laser source and the polarization element.

Embodiment 17. The system of any one of Embodiments 1-16, wherein the laser source comprises a first laser source configured to generate the first laser and a second laser source configured to generate the second laser.

Embodiment 18. The system of any one of Embodiments 1-17, wherein the laser source is further configured to: direct a third laser to a third location and direct a fourth laser to a fourth location.

Embodiment 19. The system of Embodiment 18, wherein the third laser intersects the first laser and/or the second laser and/or wherein the fourth laser intersects the first laser and/or the second laser.

Embodiment 20. The system of Embodiment 18, wherein the third laser is orthogonal to the first laser and/or the second laser and/or wherein the fourth laser is orthogonal to the first laser and/or the second laser.

Embodiment 21. The system of any one of Embodiments 18-20, wherein the melt pool is surrounded by the first laser, the second laser, the third laser, and the fourth laser.

Embodiment 22. The system of any one of Embodiments 18-21, wherein the laser source comprises: a single parallel laser source configured to generate a single parallel laser and a first beamsplitter configured to split the single parallel laser into the first laser and the second laser and a single orthogonal laser source configured to generate a single orthogonal laser and a second beamsplitter configured to split the single orthogonal laser into the third laser and the fourth laser.

Embodiment 23. The system of Embodiment 22, wherein the first beamsplitter or the second beamsplitter comprises a polarizing beamsplitter.

Embodiment 24. The system of Embodiment 22 or 23, wherein the first beamsplitter or the second beamsplitter comprises a beam displacer.

Embodiment 25. The system of any one of Embodiments 22-24, wherein the laser source further comprises a first polarization element or a second polarization element.

Embodiment 26. The system of Embodiment 25, wherein the first polarization element is located between the single parallel laser source and the first beamsplitter or the second polarization element is located between the single perpendicular laser source and the second beamsplitter.

Embodiment 27. The system of Embodiment 25, wherein the first beamsplitter is located between the single parallel laser source and the first polarization element or the second beamsplitter is located between the single perpendicular laser source and the second polarization element.

Embodiment 28. The system of any one of Embodiments 18-21, wherein the laser source comprises a first laser source configured to generate the first laser, a second laser source configured to generate the second laser, a third laser source configured to generate the third laser, and a fourth laser source configured to generate the fourth laser.

Embodiment 29. The system of any one of Embodiments 18-28, wherein the optical detector is further configured to: receive a third reflection of the third laser from the third location and generate a third laser reflection signal therefrom and receive a fourth reflection of the fourth laser upon reflection from the fourth location and generate a fourth laser reflection signal therefrom.

Embodiment 30. The system of Embodiment 29, wherein the controller is further configured to: receive the third reflection signal and determine a third height and/or a third position of the production at the third location therefrom and receive the fourth reflection signal and determine a fourth height and/or a fourth position of production at the fourth location therefrom.

Embodiment 31. The system of any one of Embodiments 1-30, wherein the optical detector is located off-axis from the energy source.

Embodiment 32. The system of Embodiment 31, further comprising a fold mirror located between the table and the optical detector.

Embodiment 33. The system of any one of Embodiments 1-32, wherein the energy source comprises an optical energy source and the energy comprises optical energy.

Embodiment 34. The system of Embodiment 33, wherein the optical energy source comprises a laser energy source and the optical energy comprises laser energy.

Embodiment 35. A method comprising:
directing an energy source to direct energy to an irradiation position during a 3D printing process, wherein the energy directed to the irradiation position is irradiated to a production of a 3D printed component on a table, thereby generating a melt pool on the production;
directing a laser source to: direct a first laser to a first location and direct a second laser to a second location;
directing an optical detector to: receive a first reflection of the first laser from the first location and generate a first reflection signal therefrom and receive a second reflection of the second laser from the second location and generate a second reflection signal therefrom; and
directing a controller to: receive the first reflection signal and receive the second reflection signal,
wherein the irradiation position is between the first location and the second location.

Embodiment 36. The method of Embodiment 35, further comprising directing the controller to: determine a first height and/or a first position of the production at the first location based on the first reflection signal and determine a second height and/or a second position of the production at the second location based on the second reflection signal.

Embodiment 37. The method of Embodiment 35 or 36, wherein the first laser is a first laser and/or wherein the second laser is a second laser.

Embodiment 38. The method of Embodiment 35 or 36, wherein the first laser is a first point laser and/or wherein the second laser is a second point laser.

Embodiment 39. The method of any one of Embodiments 35-38, further comprising directing a scanner to move the table and/or the energy to scan the irradiation position on the production to thereby change a relative position between the energy and the production during the 3D printing process.

Embodiment 40. The method of Embodiment 39, wherein, with respect to a scanning direction of the energy, the first location is a first distance ahead of the melt pool and/or the second location is a second distance behind the melt pool.

Embodiment 41. The method of any one of Embodiments 35-40, wherein the first reflection signal is a first laser triangulation signal and/or wherein the second reflection signal is a second laser triangulation signal.

Embodiment 42. The method of any one of Embodiments 35-41, wherein the first laser and the second laser are irradiated on the production during the 3D printing process.

Embodiment 43. The method of any one of Embodiments 35-42, further comprising directing a melt pool detector to receive a melt pool radiation from the melt pool and to generate a melt pool radiation signal therefrom, and further comprising directing the controller to receive the melt pool radiation signal and to determine a melt pool height and/or a melt pool position based on the melt pool radiation signal.

Embodiment 44. The method of any one of Embodiments 35-42, further comprising directing the optical detector to receive a melt pool radiation from the melt pool and to generate a melt pool radiation signal therefrom and further comprising directing the controller to receive the melt pool radiation signal and to determine a melt pool height and/or a melt pool position based on the melt pool radiation signal.

Embodiment 45. The method of any one of Embodiments 35-44, wherein the laser source comprises a single laser source configured to generate a single laser and a beamsplitter configured to split the single laser into the first laser and the second laser.

Embodiment 46. The method of Embodiment 45, wherein the beamsplitter comprises a polarizing beamsplitter.

Embodiment 47. The method of Embodiment 45 or 46, wherein the beamsplitter comprises a beam displacer.

Embodiment 48. The method of any one of Embodiments 45-47, wherein the laser source further comprises a polarization element.

Embodiment 49. The method of Embodiment 48, wherein the polarization element is located between the single laser source and the beamsplitter.

Embodiment 50. The method of Embodiment 48, wherein the beamsplitter is located between the single laser source and the polarization element.

Embodiment 51. The method of any one of Embodiments 35-50, wherein the laser source comprises a first laser source configured to generate the first laser and a second laser source configured to generate the second laser.

Embodiment 52. The method of any one of Embodiments 35-51, further comprising directing the laser source to: direct a third laser to a third location and direct a fourth laser to a fourth location.

Embodiment 53. The method of Embodiment 52, wherein the third laser intersects the first laser and/or the second laser and/or wherein the fourth laser intersects the first laser and/or the second laser.

Embodiment 54. The method of Embodiment 52, wherein the third laser is orthogonal to the first laser and/or the second laser and/or wherein the fourth laser is orthogonal to the first laser and/or the second laser.

Embodiment 55. The method of any one of Embodiments 52-54, wherein the melt pool is surrounded by the first laser, the second laser, the third laser, and the fourth laser.

Embodiment 56. The method of any one of Embodiments 52-55, wherein the laser source comprises: a single parallel laser source configured to generate a single parallel laser and a first beamsplitter configured to split the single parallel laser into the first laser and the second laser and a single orthogonal laser source configured to generate a single orthogonal laser and a second beamsplitter configured to split the single orthogonal laser into the third laser and the fourth laser.

Embodiment 57. The method of Embodiment 56, wherein the first beamsplitter or the second beamsplitter comprises a polarizing beamsplitter.

Embodiment 58. The method of Embodiment 56 or 57, wherein the first beamsplitter or the second beamsplitter comprises a beam displacer.

Embodiment 59. The method of any one of Embodiments 56-58, wherein the laser source further comprises a first polarization element or a second polarization element.

Embodiment 60. The method of Embodiment 59, wherein the first polarization element is located between the single parallel laser source and the first beamsplitter or the second polarization element is located between the single perpendicular laser source and the second beamsplitter.

Embodiment 61. The method of Embodiment 59, wherein the first beamsplitter is located between the single parallel laser source and the first polarization element or the second beamsplitter is located between the single perpendicular laser source and the second polarization element.

Embodiment 62. The method of any one of Embodiments 52-55 wherein the laser source comprises a first laser source configured to generate the first laser, a second laser source configured to generate the second laser, a third laser source configured to generate the third laser, and a fourth laser source configured to generate the fourth laser.

Embodiment 63. The method of any one of Embodiments 52-62, further comprising directing the optical detector to: receive a third reflection of the third laser from the third location and generate a third laser reflection signal therefrom and receive a fourth reflection of the fourth laser upon reflection from the fourth location and generate a fourth laser reflection signal therefrom.

Embodiment 64. The method of Embodiment 63, further comprising directing the controller to: receive the third reflection signal and determine a third height and/or a third position of the production at the third location therefrom and receive the fourth reflection signal and determine a fourth height and/or a fourth position of production at the fourth location therefrom.

Embodiment 65. The method of any one of Embodiments 35-64, wherein the optical detector is located off-axis from the energy source.

Embodiment 66. The method of Embodiment 65, wherein a fold mirror is located between the table and the optical detector.

Embodiment 67. The method of any one of Embodiments 35-66, wherein the energy source comprises an optical energy source and the energy comprises optical energy.

Embodiment 68. The method of Embodiment 67, wherein the optical energy source comprises a laser energy source and the optical energy comprises laser energy.

1. A system comprising:
a table configured to support a production of a 3D printed component during a 3D printing process;
an energy source configured to direct energy to an irradiation position during the 3D printing process, wherein the energy directed to the irradiation position is irradiated to the production, thereby generating a melt pool on the production;
a laser source configured to: direct a first laser to a first location and direct a second laser to a second location;
an optical detector configured to: receive a first reflection of the first laser from the first location and generate a first reflection signal therefrom and receive a second reflection of the second laser from the second location and generate a second reflection signal therefrom; and
a controller configured to: receive the first reflection signal and receive the second reflection signal;
wherein the irradiation position is between the first location and the second location.

2. The system of claim 1, wherein the controller is further configured to: determine a first height and/or a first position of the production at the first location based on the first reflection signal and determine a second height and/or a second position of the production at the second location based on the second reflection signal.

3. The system of claim 1, wherein the first laser is a first laser and/or wherein the second laser is a second laser.

4. The system of claim 1, wherein the first laser is a first point laser and/or wherein the second laser is a second point laser.

5. The system of claim 1, further comprising: a scanner configured to move the table and/or the energy to scan the irradiation position on the production to thereby change a relative position between the energy and the production during the 3D printing process.

6. The system of claim 5, wherein, with respect to a scanning direction of the energy, the first location is a first distance ahead of the melt pool and/or the second location is a second distance behind the melt pool.

7. The system of claim 1, wherein the first reflection signal is a first laser triangulation signal and/or wherein the second reflection signal is a second laser triangulation signal.

8. The system of claim 1, wherein the first laser and the second laser are irradiated on the production during the 3D printing process.

9. The system of claim 1, further comprising a melt pool detector configured to receive a melt pool radiation from the melt pool and to generate a melt pool radiation signal therefrom, wherein the controller is further configured to receive the melt pool radiation signal and to determine a melt pool height and/or a melt pool position based on the melt pool radiation signal.

10. The system of claim 1, wherein the optical detector is further configured to receive a melt pool radiation from the melt pool and to generate a melt pool radiation signal therefrom and wherein the controller is configured to receive the melt pool radiation signal and to determine a melt pool height and/or a melt pool position based on the melt pool radiation signal.

11. The system of claim 1, wherein the laser source comprises a single laser source configured to generate a single laser and a beamsplitter configured to split the single laser into the first laser and the second laser.

12. The system of claim 11, wherein the beamsplitter comprises a polarizing beamsplitter.

13. The system of claim 11, wherein the beamsplitter comprises a beam displacer.

14. The system of claim 11, wherein the laser source further comprises a polarization element.

15. The system of claim 14, wherein the polarization element is located between the single laser source and the beamsplitter.

16. The system of claim 14, wherein the beamsplitter is located between the single laser source and the polarization element.

17. The system of claim 1, wherein the laser source comprises a first laser source configured to generate the first laser and a second laser source configured to generate the second laser.

18. The system of claim 1, wherein the laser source is further configured to: direct a third laser to a third location and direct a fourth laser to a fourth location.

19. The system of claim 18, wherein the third laser intersects the first laser and/or the second laser and/or wherein the fourth laser intersects the first laser and/or the second laser.

20. The system of claim 18, wherein the third laser is orthogonal to the first laser and/or the second laser and/or wherein the fourth laser is orthogonal to the first laser and/or the second laser.

21. The system of claim 18, wherein the melt pool is surrounded by the first laser, the second laser, the third laser, and the fourth laser.

22. The system of claim 18, wherein the laser source comprises: a single parallel laser source configured to generate a single parallel laser and a first beamsplitter configured to split the single parallel laser into the first laser and the second laser and a single orthogonal laser source configured to generate a single orthogonal laser and a second beamsplitter configured to split the single orthogonal laser into the third laser and the fourth laser.

23. The system of claim 22, wherein the first beamsplitter or the second beamsplitter comprises a polarizing beamsplitter.

24. The system of claim 22, wherein the first beamsplitter or the second beamsplitter comprises a beam displacer.

25. The system of claim 22, wherein the laser source further comprises a first polarization element or a second polarization element.

26. The system of claim 25, wherein the first polarization element is located between the single parallel laser source and the first beamsplitter or the second polarization element is located between the single perpendicular laser source and the second beamsplitter.

27. The system of claim 25, wherein the first beamsplitter is located between the single parallel laser source and the first polarization element or the second beamsplitter is located between the single perpendicular laser source and the second polarization element.

28. The system of claim 18, wherein the laser source comprises a first laser source configured to generate the first laser, a second laser source configured to generate the second laser, a third laser source configured to generate the third laser, and a fourth laser source configured to generate the fourth laser.

29. The system of claim 18, wherein the optical detector is further configured to: receive a third reflection of the third laser from the third location and generate a third laser reflection signal therefrom and receive a fourth reflection of the fourth laser upon reflection from the fourth location and generate a fourth laser reflection signal therefrom.

30. The system of claim 29, wherein the controller is further configured to: receive the third reflection signal and determine a third height and/or a third position of the production at the third location therefrom and receive the fourth reflection signal and determine a fourth height and/or a fourth position of production at the fourth location therefrom.

31. The system of claim 1, wherein the optical detector is located off-axis from the energy source.

32. The system of claim 31, further comprising a fold mirror located between the table and the optical detector.

33. The system of claim 1, wherein the energy source comprises an optical energy source and the energy comprises optical energy.

34. The system of claim 33, wherein the optical energy source comprises a laser energy source and the optical energy comprises laser energy.
